(19) United States
(12) Patent Application Publication
(10) Pub. No.: US 2026/0055846 A1
(43) Pub. Date: Feb. 26, 2026

(54) PRESSURE VESSEL ASSEMBLY AND PRESSURE VESSEL PROTECTOR

(71) Applicants: Hyundai Motor Company, Seoul (KR); Kia Corporation, Seoul (KR)

(72) Inventor: Chan Jin Kim, Hwaseong-si (KR)

(21) Appl. No.: 19/207,129

(22) Filed: May 13, 2025

(30) Foreign Application Priority Data
Aug. 26, 2024 (KR) 10-2024-0114624

(51) Int. Cl. F17C 1/04

(52) U.S. Cl. CPC F17C 1/04; F17C 2201/0109; F17C 2205/0308

(57) ABSTRACT

In an embodiment a pressure vessel assembly includes a pressure vessel having a cylinder part and dome-shape dome parts arranged at opposite ends of the cylinder part and protectors, each protector including an inner protector having a first strength and an outer protector having a second strength being higher than the first strength, wherein the outer protector surrounds a surface of the inner protector, and wherein the protector covers an outer surface of a corresponding dome part.

### CROSS-REFERENCE TO RELATED APPLICATIONS

This application claims priority of Korean Application No. 10-2024-0114624, filed on Aug. 26, 2024, which application is hereby incorporated herein by reference.

### TECHNICAL FIELD

The present disclosure relates to a pressure vessel assembly and a pressure vessel protector, and more particularly, to a pressure vessel assembly and a pressure vessel protector configured for minimizing damage to and improving safety and reliability of a pressure vessel.

### BACKGROUND

A hydrogen vehicle (e.g., a passenger car or a commercial vehicle) is configured to travel while generating electricity by itself through a chemical reaction between hydrogen and oxygen and driving a motor. More specifically, a hydrogen vehicle includes a pressure vessel, in which hydrogen (H₂) is stored, a fuel cell stack that generates electricity through oxidation-reduction reactions of hydrogen and oxygen (O₂), various devices for draining generated water, a battery that stores electricity produced in the fuel cell stack, a controller that converts and controls the produced electricity, a motor that generates a driving force, and the like.

As the pressure vessel of the hydrogen vehicle, a pressure vessel of type 4 may be used. The pressure vessel of type 4 may include a liner (e.g., a nonmetallic material), and a carbon fiber layer that is formed by winding a carbon fiber composite material on an outer surface of the liner.

However, due to the structural characteristics of opposite dome parts of the pressure vessel formed in a dome shape, it is difficult to wind the carbon fiber composite material to a sufficient thickness on the dome parts of the pressure vessel, and thus, it difficult to sufficiently secure a structural strength of the dome parts of the pressure vessel.

In particular, when an impact (e.g., an impact from dropping or collision) is applied to the dome parts of the pressure vessel, the pressure vessel is easily damaged, and thus, the risk of leakage of hydrogen is increased and the safety and reliability are lowered.

Accordingly, various studies have recently been conducted to ensure the structural strength of the pressure vessel (the structural strength of the dome part) and improve the safety and reliability, but it is still insufficient, and development for them is required.

### SUMMARY

Embodiments solve the above-mentioned problems occurring in the prior art while maintaining advantages achieved by the prior art.

Embodiments provide a pressure vessel assembly and a pressure vessel protector configured for minimizing damage to and improving safety and reliability of the pressure vessel.

Embodiments provide structural strength of a dome part of a pressure vessel and improves a durability thereof.

First of all, an embodiment improves an impact absorption performance of a protector and minimizes an impact transmitted to a dome part of a pressure vessel in the case of an impact, such as an accident.

Furthermore, an embodiment of the present disclosure simplifies a structure and a manufacturing process and improves a manufacturing efficiency.

The problems to be solved in the embodiments are not limited thereto, and purposes and effects that may be recognized from the means and the embodiment forms for solving the problems, which are described below, may be included in the problems to be solved.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, a pressure vessel assembly includes a pressure vessel including a cylinder part, and dome-shape dome parts formed at opposite ends of the cylinder part, and protectors each including an inner protector that surrounds an outer surface of the corresponding dome part and having a first strength, and an outer protector having a second strength being higher than the first strength and that surrounds an entire surface of the inner protector.

This is to minimize an impact applied to the pressure vessel and improve safety and reliability.

That is, due to the structural characteristics of opposite dome parts of the pressure vessel formed in a dome shape, it is difficult to wind the carbon fiber composite material to a sufficient thickness on the dome parts of the pressure vessel, and thus, it difficult to sufficiently secure a structural strength of the dome parts of the pressure vessel. In particular, when an impact (e.g., an impact from dropping or collision) is applied to the dome parts of the pressure vessel, the pressure vessel is easily damaged, and thus, the risk of leakage of hydrogen is increased and the safety and reliability are lowered.

However, in an embodiment of the present disclosure, the protector is configured to cover the outer surface of the dome part, and the protector includes the inner protector and the outer protector having different strength so that the structural strength of the dome part of the pressure vessel may be secured and durability may be improved.

First of all, by providing the inner protector having a relatively low strength (a first strength) in an interior of the outer protector having a high strength (a second strength), an impact force applied to the protector may be absorbed (alleviated) in the inner protector, so that an impact transmitted to the pressure vessel via the protector in the case of an impact, such as an accident, may be minimized and damage to the pressure vessel may be minimized.

The protector may be provided in various structures including the inner protector and the outer protector.

According to an embodiment of the present disclosure, the protector may be configured to have a thickness that gradually becomes larger from one end that is adjacent to the cylinder part to another end thereof.

According to an embodiment of the present disclosure, the inner protector may be configured to have a strength that gradually increases from an inside to an outside thereof.

According to an embodiment of the present disclosure, the outer protector may be configured to have a strength that gradually increases from an inside to an outside thereof.

The protector including the inner protector and the outer protector having different strengths may be manufactured according to required conditions and design specifications.

According to an embodiment of the present disclosure, the inner protector and the outer protector may be provided as a unitary body through a single process.

According to an embodiment of the present disclosure, the protector may be formed by foaming the foaming material in a direction that faces the cylinder part from the dome part, and the outer protector may have a higher density that that of the inner protector by adjusting a foaming speed or time.

According to an embodiment of the present disclosure, each of the protectors may include a curved attachment region having a curvature corresponding to an outer surface of the pressure vessel and closely attached to the outer surface of the pressure vessel.

In this way, by providing the curved attachment region on the inner surface of the protector and closely attaching the curved attachment region to the outer surface of the pressure container, a contact area between the pressure container and the curved attachment region may be sufficiently secured, and the impact resistance by the protector may be further improved.

According to an embodiment of the present disclosure, the protector may include a planar surface region that defines a portion of the outer surface of the protector.

This is caused by the aspect that stresses are concentrated at an impact portion (a contact portion with the ground) as the outer surface of the protector point-contacts the ground when the protector falls on the ground, when the outer surface of the protector is formed to be curved, and thus, the protector is easily damaged and the impact transmitted to the pressure container is increased.

However, according to an embodiment of the present disclosure, the impact and the stress applied to the protector may be uniformly distributed along the planar surface region by providing the planar surface region with a linear (planar) shape on the outer surface of the protector and allowing the planar surface region to line-contact or surface-contact the ground when the protector falls on the ground, so that damage to the protector may be minimized and the impact transmitted to the pressure vessel may be reduced.

According to an embodiment of the present disclosure, the planar surface region may be inclined at a preset first reference angle with respect to a reference line along an axial direction of the pressure vessel.

The first reference angle may be variously changed according to the required conditions and design specifications.

According to an embodiment of the present disclosure, the first reference angle may be defined as being 30 degrees to 60 degrees. In some embodiments, the first reference angle may be defined as being 45 degrees.

According to an embodiment of the present disclosure, each of the protectors may include a stepped region provided at one end of the planar surface region, and on which a binding band that binds the protector to the pressure vessel is seated.

According to an embodiment of the present disclosure, the binding band may have a first width, and the stepped region may have a second width being greater than or equal to the first width.

In this way, because the stepped region has the second width that is greater than or equal to the first width of the binding band, the seating state of the binding band on the stepped region may be stably maintained, and the slipping of the binding band may be minimized.

According to an embodiment of the present disclosure, the protector may include a rounded region formed between the stepped region and the planar surface region.

In this way, according to an embodiment of the present disclosure, by providing the rounded region between the stepped region and the planar surface region, rapid bending of the binding band wound on the planar surface region via the stepped region may be minimized and concentration of stresses at a corner portion (a second between the stepped region and the planar surface region) of the stepped region may be minimized, so that deformation and damage to the protector by the tension of the binding band may be minimized.

According to an embodiment of the present disclosure, each of the protectors may include a curved guide region provided at another end of the planar surface region and that guides the binding band having passed via the stepped region to the cylinder region.

In this way, in an embodiment of the present disclosure, by allowing the binding band that has passed via the planar surface region to be wound on the outer surface of the cylinder part via the curved guide region having a specific curvature, the binding band may be more effectively closely attached to the protector and the pressure vessel, and thus, the binding force (a binding force of the protector to the pressure vessel) by the binding band may be further improved, so that the disposition state of the protector for the pressure vessel may be firmly maintained and separation of the protector may be minimized.

According to an embodiment of the present disclosure, a protector for protecting a pressure vessel including a cylinder part, and a dome-shaped dome part formed at one of opposite ends of the cylinder part includes an inner protector that surrounds an outer surface of the dome part and having a first strength, and an outer protector having a second strength being higher than the first strength and that surrounds an entire surface of the inner protector.

According to an embodiment of the present disclosure, the strength of the inner protector may gradually increase from an inside to an outside thereof, and the strength of the outer protector may gradually increase from an inside to an outside thereof.

According to an embodiment of the present disclosure, the outer protector may include a planar surface region defining a portion of the outer surface of the outer protector, and the planar surface region may be inclined at a preset reference angle with respect to an axial direction of the pressure vessel.

According to another embodiment of the present disclosure, the outer protector may include a stepped region provided at one end of the planar surface region, and on which a binding band that binds the protector to the pressure vessel is seated.

According to an embodiment of the present disclosure, the outer protector may include a curved attachment region having a curvature corresponding to an outer surface of the pressure vessel and closely attached to the outer surface of the pressure vessel, a rounded region formed between the stepped region and the planar surface region, and a curved guide region provided at another end of the planar surface region and that guides the binding band having passed via the stepped region to the cylinder region.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a pressure vessel assembly according to an embodiment of the present disclosure;

FIGS. 2 and 3 are views illustrating a pressure vessel protector according to an embodiment of the present disclosure; and

FIG. 4 illustrates a pressure vessel assembly according to an embodiment of the present disclosure, and is a view illustrating a binding band.

### DETAILED DESCRIPTION OF ILLUSTRATIVE EMBODIMENTS

Hereinafter, embodiments of the present disclosure will be described in detail with reference to the accompanying drawings.

However, the technical spirit of the present disclosure is not limited some embodiments, and may be implemented in various different forms, and one or more of the components of the embodiments may be selectively coupled to each other or replaced with each other to be used without departing from the technical spirit of the present disclosure.

Furthermore, the terms (including technical and scientific terms) used in the embodiments of the present disclosure may be construed as meanings that may be generally understood to those skilled in the art, to which the present disclosure pertains, unless particularly defined and described clearly.

Furthermore, the terms used in the embodiments of the present disclosure are provided to describe embodiments, not intended to limit the present disclosure.

In the specification, a singular form may include a plural form unless particularly mentioned in the context, and an expression “at least one (one or more) of A, B, and C” may include one or more of all combinations of A, B, and C.

In describing components of the embodiments of the present disclosure, the terms first, second, A, B, (a), (b), and the like may be used herein.

These terms are only used to distinguish one component from another component, but do not limit the corresponding components irrespective of the nature, order, or priority of the corresponding components.

Furthermore, when it is described that a component is ‘connected to “, ‘coupled to’, or ‘electrically connected to” a second component, the component may not only be directly connected to, coupled to, or electrically connected to the second component, but also be ‘connected to’, ‘coupled to’, or ‘electrically connected to’ the second component due to a third component therebetween.

Furthermore, when it is described that a component is formed or disposed “on an upper side of (above) or on a lower side of (under)” a second component, the two components may not only directly contact each other but also a third component may be formed or disposed between the two components. Furthermore, the expression “on an upper side of (above) or on a lower side of (under)” may mean not only an upward direction but also a downward direction with respect to one component.

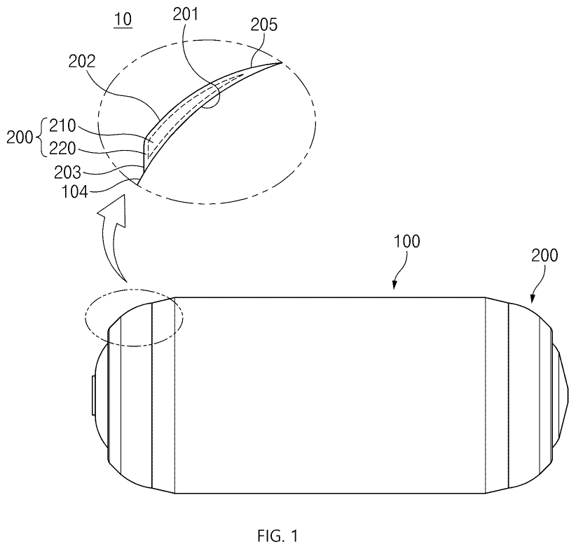

Referring to FIGS. 1 to 4, a pressure vessel assembly 10 according to an embodiment of the present disclosure includes a pressure vessel 100 including a cylinder part 102, and dome-shape dome parts 104 that are formed at opposite ends of the cylinder part 102, and protectors 200 each including an inner protector 210 that is configured to surround an outer surfaces of the corresponding dome part 104 and having a first strength, and an outer protector 220 having a second strength that is higher than the first strength and configured to surround an entire surface of the inner protector 210.

For reference, the pressure vessel assembly 10 according to an embodiment may be used to store a high-pressure fluid (a liquid state or gases state), and the kind and characteristics of the fluid stored in the pressure vessel 100 is neither limited nor restricted by the present disclosure.

Hereinafter, an example of using the pressure vessel assembly 10 according to an embodiment of the present disclosure as a hydrogen tank of a hydrogen storage system that is applied to a mobility, such as various fuel cell vehicles (for example, trucks), ships, or aircrafts, to which a fuel cell stack may be applied, will be described as an example.

A high-pressure fluid (e.g., hydrogen) may be store in an interior of the pressure vessel 100.

The pressure vessel 100 may be provided in various structures according to required conditions and design specifications, and the present disclosure is neither limited nor restricted by the structure of the pressure vessel 100.

According to an embodiment of the present disclosure, the pressure vessel 100 may include a liner 110 having a storage space in an interior thereof, and a carbon fiber layer 120 that is configured to surround an outer surface of the liner 110, and the pressure vessel 100 may be selectively expanded or contracted depending on the pressure of the fluid (for example, hydrogen) stored in the pressure vessel 100.

The liner 110 is formed as a hollow structure having a storage space in an interior thereof, and high-pressure compressed hydrogen may be stored in the storage space.

The material of the liner 110 may be variously changed according to required conditions and design specifications, and the present disclosure is neither limited nor restricted by the material of the liner 110.

In some embodiments, the liner 110 may be formed of a nonmetallic material, such as high-density plastic having an excellent restoring force and an excellent fatigue. According to another embodiment of the present disclosure, it is also possible to form the liner of a metallic material (e.g., aluminum) or other materials.

The carbon fiber layer 120 is formed to surround an entire outer surface of the liner 110.

The carbon fiber layer 120 may be formed of various materials according to required conditions and design specifications, and the present disclosure is neither limited nor restricted by the material and characteristics of the carbon fiber layer 120.

As an example, the carbon fiber layer 120 may be formed by winding a composite material impregnated with epoxy and a thermosetting or thermoplastic resin in carbon fiber, and a pre-impregnated to prepreg on the outer surface of liner 110.

A winding structure and a winding method for the carbon fiber composite material may be variously changed according to required conditions and design specifications, and the present disclosure is neither limited nor restricted by the winding method for the carbon fiber composite material.

The carbon fiber layer 120 may be formed by winding several layers of carbon fiber composite materials in various patterns (for example, clockwise winding, counterclockwise winding, diagonal winding, or the like) on the outer surface of the liner 110.

For example, the carbon fiber composite material may be wound on the outer surface of the liner 110 via a winding jig (not illustrated), and a winding angle of the carbon fiber composite material with respect to the liner 110 may be changed by adjusting a disposition angle (a posture) of the winding jig with respect to the liner 110.

The carbon fiber composite material wound on the outer surface of the liner 110 is cured through a subsequent heat treatment process to form the carbon fiber layer 120. As an example, the carbon fiber composite material wound on the outer surface of the liner 110 may be cured through heat treatment at a temperature of 90 degrees or more for a preset time period.

More specifically, the pressure vessel 100 includes a cylinder part 102, and a dome-shaped dome part 104 that is formed at one end of the cylinder part 102.

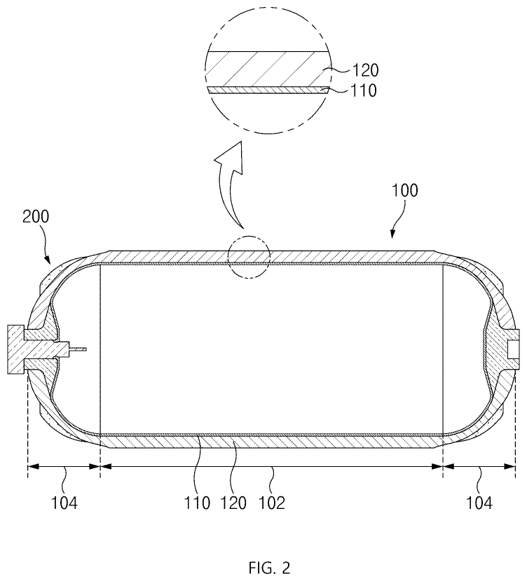

The cylinder part 102 may be formed to have a substantially hollow cylindrical shape, and the dome parts 104 having a dome shape are integrally provided at one end (a left end with reference to FIG. 2) and an opposite end (a right end with reference to FIG. 2) of cylinder part 102.

Furthermore, an entrance/exit port (not illustrated), through which hydrogen enters and exits, may be formed at the end of the dome part 104, and various parts, such as valves and pipelines, may be connected to the entrance/exit port.

The protector 200 of the pressure vessel 100 is configured to secure a structural strength of the dome part 104, to minimize an impact transmitted to the dome part 104 of the pressure vessel 100 in the case of an impact due to an accident or the like, to minimize a damage to the pressure vessel 100.

The protector 200 may be provided in various structures that may surround the outer surface of the dome part 104, and the present disclosure is neither limited nor restricted by the structure and shape of the protector 200.

In some embodiments, the protector 200 may be formed to have a dome shape corresponding to the dome part 104 and may be provided (formed in a ring shape) to partially surround the outer surface of the dome part 104. According to another embodiment of the present disclosure, the protector may be configured to cover the entire outer surface of the dome part.

In more detail, the protector 200 of the pressure vessel 100 includes an inner protector 210 that is configured to surround the outer surface of the dome part 104 and has a first strength, and an outer protector 220 that has a second strength that is higher than the first strength and is configured to surround an entire surface of the inner protector 200.

Here, the aspect that the outer protector 220 surrounds the entire surface of the inner protector 210 is defined as the outer protector 220 surrounding both an inner surface (an inner surface that faces an outer peripheral surface of the pressure vessel 100) of the inner protector 210 and an outer surface of the inner protector 210.

This is caused because the carbon fiber layer 120 corresponding to the dome part 104 of the pressure vessel 100 may be easily damaged when an impact applied to the protector due to dropping, collision, or the like is directly transmitted to the dome part 104 of the pressure vessel 100.

However, according to an embodiment of the present disclosure, because the protector 200 is configured to cover the outer surface of the dome part 104 and the protector 200 includes the inner protector 210 and the outer protector 220 having different strengths, the inner protector may absorb (alleviate) an impact force applied to the protector 200, so that an impact transmitted to the pressure vessel 100 via the protector 200 in case of an impact, such as an accident, may be minimized and a damage to the pressure vessel 100 may be minimized.

The protector 200 may be provided in various structures including the inner protector 210 and the outer protector 220, and embodiments of the present disclosure is neither limited nor restricted by the structure and shape of the protector 200 including the inner protector 210 and the outer protector 220.

According to an embodiment of the present disclosure, the protector 200 may have a thickness that increases from one end (a right end with reference to FIG. 1) that is closer to the cylinder part 102 to an opposite end (a left end with reference to FIG. 1) that is further away from the cylinder part 102.

According to the above-described and illustrated embodiment of the present disclosure, it has been described as an example that the protector 200 is formed to have a thickness that gradually increases from the one end that is adjacent to the cylinder part 102 to the opposite end thereof, but according to another embodiment of the present disclosure, it is possible to configure the protector such that it has a uniform thickness or to configured the protector such that a specific portion thereof partially has a larger (or smaller) thickness.

According to an embodiment of the present disclosure, the inner protector 210 may have a strength that gradually increases from an inside to an outside thereof.

Here, the aspect that the inner protector 210 has the strength that gradually increases from the inside to the outside thereof may be understood that the strength of the inner protector gradually increases from the inside (for example, a central portion of the inner protector) to the outside (for example, an outermost portion of the inner protector) thereof.

According to an embodiment of the present disclosure, the outer protector 220 may be configured to have a strength that gradually increases from an inside to an outside thereof.

Here, the aspect that the outer protector 220 has the strength that gradually increases from the inside to the outside thereof may be understood that the strength of the outer protector gradually increases from the inside (for example, an inner surface of the outer protector, which is adjacent to the inner protector) to the outside (for example, an outer surface of the outer protector) thereof.

In the above-described and illustrated embodiment of the present disclosure, it has been described as an example that the inner protector 210 and the outer protector 220 have a strength that gradually increases from the inside to the outside thereof is described, but according to another embodiment of the present disclosure, it is also possible to configure the inner protector and the outer protector such that they have a constant strength as a whole.

The protector 200 including the inner protector 210 and the outer protector 220 having different strengths may be manufactured in various methods according to the required conditions and design specifications, and the present disclosure is neither limited nor restricted by the manufacturing method of the protector 200.

According to an embodiment of the present disclosure, the inner protector 210 and the outer protector 220 may be provided as a unitary and integrated body through a single process.

According to an embodiment of the present disclosure, the protector 200 may be formed by foaming the foaming material in a direction that faces the cylinder part 102 from the dome part 104 and cooling it, and the outer protector 220 may be made to have a higher strength than that of the inner protector 210 by adjusting the foaming speed or time to have a higher density than that of the inner protector 210. In some embodiments, the protector 200 may be formed through a common open-mold foaming method.

The foaming material for forming the protector 200 may be formed of various materials according to the required conditions and design specifications, and the present disclosure is neither limited nor restricted by the material and characteristics of the foaming material.

According to an embodiment of the present disclosure, a common polymer material may be used as a foaming material for molding the protector 200.

This is due to the repeated expansion or contraction of the pressure vessel 100, and by using a highly durable polymer material as the foaming material of the protector 200, the durability of the protector 200 may be stably secured even when the pressure vessel 100 is repeatedly expanded and contracted.

Moreover, a low-density thermosetting polymer material (for example, Polyurethane foam (PUF) or Expanded polypropylene (EPP) may be used as the foaming material.

In this way, by using a polymer material with a low density (e.g., 150 to 400 kg/m³) characteristics as the foaming material, it is possible to minimize a damage (deformation) to the protector 200 due to a tension (a tension, by which the binding band is wound on the protector) of the binding band 300 while the shock absorption performance of the protector 200 is ensured, and it may contribute to the light weight of the protector 200. Furthermore, due to the thermosetting property of the foaming material, it is possible to minimize deformation of the protector 200 and deterioration in the impact absorption performance due to the thermal exposure (e.g., an increase in the temperature of the surrounding environment).

Furthermore, various additives, such as refractory materials (e.g., expanded graphite) for improving a resistance when being exposed to flames may be added to the foaming material for molding the protector 200, and the present disclosure is neither limited nor restricted by the type and characteristics of the additive.

Meanwhile, in the above-described and illustrated embodiment of the present disclosure, it has been described as an example that the inner protector 210 and the outer protector 220 are simultaneously formed through a foaming method, but according to another embodiment of the present disclosure, it is also possible to form the inner protector 210 first and then to surround the circumference of the inner protector through an insert-injection method.

According to an embodiment of the present disclosure, the protector 200 may include a curved attachment region 201 that has a curvature corresponding to that of the outer surface of the pressure vessel 100 and is closely attached to the outer surface of the pressure vessel 100.

As an example, the curved attachment region 201 may be formed on the entire inner surface of the protector 200, which faces the outer surface of the pressure vessel 100.

In this way, by providing the curved attachment region 201 on the inner surface of the protector 200 and closely attaching the curved attachment region 201 to the outer surface of the pressure vessel 100, it is possible to secure a sufficient contact area between the pressure vessel 100 and the curved attachment region 201 and further improve the impact resistance performance by the protector 200.

The protector 200 may be configured to have a thickness that increases from one end (a right end with respect to FIG. 1) that is adjacent to the cylinder part 102 to an opposite end (a left end with respect to FIG. 1) thereof, and a change in thickness of the protector 200 may decrease to more than 1 mm per 2 mm in the length of the protector 200. In this way, by preventing the change in the thickness of the protector 200 from decreasing to 1 mm per 2 mm or more in the length of the protector 200, the impact absorption performance of the protector 200 may be improved as it is possible to locally form a high-strength area (the outer protector).

According to an embodiment of the present disclosure, the protector 200 may include a planar surface region 202 that defines a portion of the outer surface of the protector 200.

The planar surface region 202 is configured to minimize an impact that is transmitted to the pressure vessel 100 via the protector 200 when the pressure vessel 100 falls (or collides) on the ground.

That is, when the outer surface of the protector 200 is formed as a curved surface, the outer surface of the protector 200 point-contacts the ground when the protector 200 falls on the ground, and thus, the stress is concentrated on the impact portion (a contact portion with the ground) of the protector 200, so that the protector 200 is be easily damaged and the impact transmitted to the pressure vessel 100 is increased.

However, according to an embodiment of the present disclosure, the impact and the stress applied to the protector 200 may be uniformly distributed along the planar surface region 202 by providing the planar surface region 202 with a linear (planar) shape on the outer surface of the protector 200 and allowing the planar surface region 202 to line-contact or surface-contact the ground when the protector 200 falls on the ground, so that damage to the protector 200 may be minimized and the impact transmitted to the pressure vessel 100 may be reduced.

According to an embodiment of the present disclosure, the planar surface region 202 may be configured to be inclined at a preset first reference angle θ1 with respect to the reference line CL along the axial direction of the pressure vessel 100.

The first reference angle θ1 may be variously changed according to required conditions and design specifications, and the present disclosure is neither limited nor restricted by the size of the first reference angle θ1.

According to an embodiment of the present disclosure, the first reference angle θ1 may be defined as being 30 degrees to 60 degrees. The first reference angle θ1 may be defined as being 45 degrees.

The protector 200 may be fastened (fixed) to the pressure vessel 100 in various methods according to required conditions and design specifications.

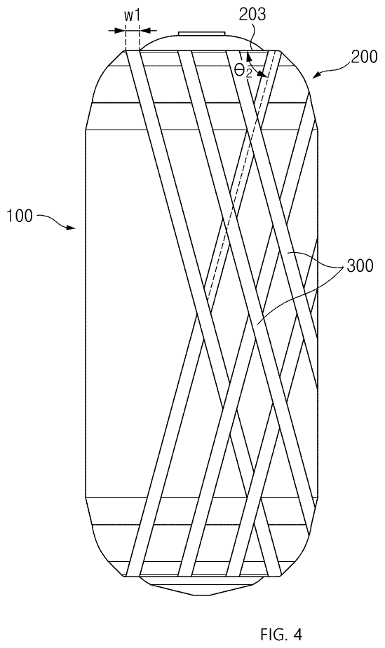

Referring to FIG. 4, according to an embodiment of the present disclosure, the protector 200 may be fastened (fixed) to the pressure vessel 100 through the binding band 300 that is wound to surround the circumferences of the protector 200 and the pressure vessel 100.

The binding band 300 may be formed of various materials according to required conditions and design specifications, and the present disclosure is neither limited nor restricted by the material and characteristics of the binding band 300.

According to an embodiment of the present disclosure, the binding band 300 may be formed of the same or similar material (e.g., a carbon fiber composite material, in which epoxy and thermosetting resin are impregnated into carbon fibers) to the above-described carbon fiber layer 120. Alternatively, the binding band 300 may be formed of a material (for example, a metal) that is different from that of the carbon fiber layer 120.

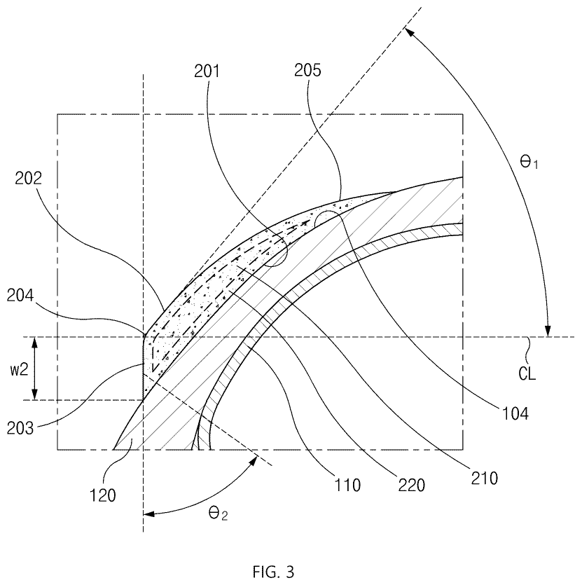

According to an embodiment of the present disclosure, the protector 200 may include a stepped region 203 that is provided at one end (a left end with reference to FIG. 3) of the planar surface region 202, and on which the binding band 300 that binds the protector 200 to the pressure vessel 100 is seated.

The stepped region 203 is configured to minimize the slipping of the binding band 300 with respect to the protector 200, to stably maintain a tension by the binding band 300 with no damage to the binding band 300, and to suppress the lifting of the protector 200 with respect to the pressure vessel 100.

The stepped region 203 may be provided in various structures that may define a seating surface, on which the binding band 300 is seated, and the present disclosure is neither limited nor restricted by the structure and shape of the stepped region 203.

As an example, the stepped region 203 may be formed in a linear (planar) shape. According to another embodiment of the present disclosure, the stepped region 203 may be formed in a spline shape, a geodesic shape, an elliptical shape, or other shapes.

The stepped region 203 may be configured to protrude in an embossed shape with respect to a vertical reference line (not illustrated) that is perpendicular to the reference line CL along the axial direction of the pressure vessel 100.

Here, the aspect that the stepped region 203 protrudes in an embossed shape with respect to a vertical reference line SL may be defined as on end (a lower end of the stepped region with reference to FIG. 3) of the stepped region 203, which is adjacent to an outermost end of the dome part 104 being disposed adjacent to an outermost end of the dome part 104 with respect to the vertical reference line SL with respect to an opposite end (an upper end of the stepped region with reference to FIG. 3) (disposed to be biased in a leftward direction with reference to FIG. 3).

In this way, by allowing the stepped region 203 to protrude in an embossed shape rather than an engraved with respect to the vertical reference line SL, the tension by the binding band 300 may be uniformly distributed in the stepped region 203 without being concentrated on a corner (a section between the stepped region and the planar surface region) of the stepped region 203, and thus, the deformation and damage to the protector 200 by the tension of the binding band 300 may be minimized.

According to an embodiment of the present disclosure, the binding band 300 may be configured to have a first width (see W1 of FIG. 4), and the stepped region 203 may be configured to have a second width (see W2 of FIG. 4) that is greater than or equal to the first width.

In this way, by allowing the stepped region 203 to have a second width W2 that is greater than or equal to the first width W1 of the binding band 300, it is possible to stably maintain the seating state of the binding band 300 and minimize the slipping of the binding band 300.

According to an embodiment of the present disclosure, the binding band 300 that passes via the stepped region 203 may be obliquely wound at a preset second reference angle θ2 with respect to a vertical reference line (not illustrated) that is perpendicular to the reference line CL along the axial direction of the pressure vessel 100.

The second reference angle θ2 may be variously changed according to required conditions and design specifications, and the present disclosure is neither limited nor restricted by the size of the second reference angle θ2.

According to an embodiment of the present disclosure, the second reference angle θ2 may be defined as being 65 degrees to 87 degrees.

This is caused by an aspect that it is difficult to accurately wind the binding band 300 at required posture and position as the binding band 300 is slipped with respect to the stepped region 203 when the winding angle (a second reference angle) of the binding band 300 with respect to the stepped region 203 is smaller than 65 degrees or greater than 87 degrees, and according to an embodiment of the present disclosure, by defining the winding angle (the second reference angle) of the binding band 300 with respect to the stepped region 203 as being 65 degrees to 87 degrees, the slipping of the binding band 300 with respect to the stepped region 203 may be minimized and the binding band 300 may be accurately wound at the required posture and position.

According to an embodiment of the present disclosure, the protector 200 may include a rounded region 204 that is formed between the stepped region 203 and the planar surface region 202.

In this way, according to an embodiment, by providing the rounded region 204 between the stepped region 203 and the planar surface region 202, rapid bending of the binding band 300 that is wounded on the planar surface region 202 via the stepped region 203 may be minimized and concentration of stresses at a corner portion (a section between the stepped region 203 and the planar surface region 202) of the stepped region 203 may be minimized, so that the deformation and damage to the protector 200 by the tension of the binding band 300 may be minimized.

In the above-described embodiment, it has been described as an example that the rounded region 204 is provided between the stepped region 203 and the planar surface region 202, but according to another embodiment of the present disclosure, it is possible to form a chamfer region between the stepped region 203 and the planar surface region 202, instead of the rounded region 204.

According to an embodiment of the present disclosure, the protector 200 may include a curved guide region 205 that is provided at an opposite end (a right end with reference to FIG. 3) of the planar surface region 202 and guides the binding band 300 that has passed via the stepped region 203 to the cylinder part 102.

The curved guide region 205 may be provided in various structures according to required conditions and design specifications, and the present disclosure is neither limited nor restricted by the structure and shape of the curved guide region 205. As an example, the curved guide region 205 may be configured to have a spline shape, a geodesic shape, or an elliptical structure.

In this way, in an embodiment of the present disclosure, by allowing the binding band 300 that has passed via the planar surface region 202 to be wound on the outer surface of the cylinder part 102 via the curved guide region 205 having a specific curvature, the binding band 300 may be more effectively closely attached to the protector 200 and the pressure vessel 100, and thus, the binding force (a binding force of the protector to the pressure vessel) by the binding band 300 may be further improved, so that the disposition state of the protector 200 for the pressure vessel 100 may be firmly maintained and separation of the protector 200 may be minimized.

Meanwhile, a gas discharge region for discharging gas during the foaming process for the protector 200 may be defined at one end (a right end with respect to FIG. 3) of the protector 200, which is adjacent to the cylinder part 102.

For reference, the gas discharge region may be defined by a gap between a mold (not illustrated) and the pressure vessel 100 that is configured to surround the circumference of the pressure vessel 100 for the foaming process for the protector 200.

The width (thickness) of the gas discharging region may be defined as being 0.2% to 1.8% of the outer diameter of the protector 200. That is, when the width (thickness) of the gas discharging region is smaller than 0.2% of the outer diameter of the protector 200, the foaming process reaction is not smooth so that a non-reaction area may occur and an air pocket may be generated, and thus, the impact absorption performance of the protector 200 may be badly influenced, and when the width (thickness) of the gas discharging region is greater than 1.8% of the outer diameter of the protector 200, the foaming process reaction occurs excessively and it is difficult to form a surface high-strength concentration area (the outer protector), so that it is that the width (thickness) of the gas discharging region is defined as being 0.2% to 1.8% of the outer diameter of the protector 200.

In the above-described and illustrated embodiment of the present disclosure, it has been described as an example that the protector 200 is fastened to the pressure vessel 100 by winding the binding band 300 on the pressure vessel 100 such that it surrounds the circumference of the protector, but according to another embodiment of the present disclosure, it is possible to adhere (fix) the protector to the pressure vessel by using an adhesive.

As described above, according to an embodiment of the present disclosure, damage to the pressure vessel may be minimized and the safety and reliability may be improved.

In particular, according to an embodiment of the present disclosure, the structural strength of the dome part of the pressure vessel may be secured, and the durability thereof may be improved.

First of all, according to an embodiment of the present disclosure, the impact absorption performance of the protector may be improved, and an impact transmitted to the dome part of the pressure vessel in the case of an impact, such as an accident, may be minimized.

Furthermore, according to an embodiment of the present disclosure, when the pressure vessel is contracted and expanded, the fastening state of the pressure vessel and the protector may be stably maintained, and separation of the protector may be minimized.

In addition, according to an embodiment of the present disclosure, the structure and the manufacturing process may be simplified and the manufacturing efficiency may be improved.

Although the embodiments have been mainly described above, they are simply examples and are not intended to limit the present disclosure, and it may be understood by those skilled in the art, to which the present disclosure pertains, that various modifications and applications that have not been described above may be possible while departing from essential characteristics of the embodiment. For example, the components that appear in detail in the embodiment may be carried out after being modified. Furthermore, it should be construed that the differences related to the modifications and applications are included in the scope of the present disclosure, which is defined in the attached claims.

What is claimed is:

1. A pressure vessel assembly comprising:
a pressure vessel comprising:
a cylinder part; and
dome-shape dome parts arranged at opposite ends of the cylinder part; and
protectors, each protector including an inner protector having a first strength and an outer protector having a second strength being higher than the first strength,
wherein the outer protector surrounds a surface of the inner protector, and
wherein the protector covers an outer surface of a corresponding dome part.

2. The pressure vessel assembly of claim 1, wherein the first strength of the inner protector gradually increases from an inside to an outside of the inner protector.

3. The pressure vessel assembly of claim 1, wherein the second strength of the outer protector gradually increases from an inside to an outside of the outer protector.

4. The pressure vessel assembly of claim 1, wherein the inner protector and the outer protector are a unitary integrated body.

5. The pressure vessel assembly of claim 1, wherein each protector includes a curved attachment region having a curvature corresponding to a curvature of the outer surface of the corresponding dome part and attached to the outer surface of the corresponding dome part.

6. The pressure vessel assembly of claim 1, wherein each protector includes a planar surface region defining a portion of the outer surface of the protector.

7. The pressure vessel assembly of claim 6, wherein the planar surface region is inclined at a preset first reference angle with respect to a reference line along an axial direction of the pressure vessel.

8. The pressure vessel assembly of claim 7, wherein the first reference angle is between 30 degrees and 60 degrees, inclusive.

9. The pressure vessel assembly of claim 6, further comprising a binding band,
wherein each protector includes a stepped region provided at one end of the planar surface region, and
wherein the binding band fixes the protectors to the pressure vessel.

10. The pressure vessel assembly of claim 9, wherein the binding band has a first width, and the stepped region has a second width being greater than or equal to the first width.

11. The pressure vessel assembly of claim 9, wherein each protector comprises comprising: a rounded region formed between the stepped region and the planar surface region.

12. The pressure vessel assembly of claim 9, wherein each protector includes a curved guide region provided at another end of the planar surface region, and wherein the curved guide region is configured to guide the binding band over the protector.

13. The pressure vessel assembly of claim 1, wherein each protector has a thickness that increases from one end of the protector being adjacent to the cylinder part to another end protector being further away from the cylinder part.

14. The pressure vessel assembly of claim 1,
wherein each protector comprises a foaming material, and
wherein the outer protector has a density being higher than that of the inner protector.

15. The pressure vessel assembly of claim 1, wherein the outer protector surrounds an entire surface of the inner protector.

16. A protector for protecting a pressure vessel including a cylinder part, and a dome-shaped dome part arranged at an end of the cylinder part, the protector comprising:
an inner protector having a first strength; and
an outer protector having a second strength being higher than the first strength and surrounding an entire surface of the inner protector,
wherein the protector is configured to cover the dome part.

17. The protector of claim 16,
wherein the strength of the inner protector gradually increases from an inside to an outside of the inner protector, and
wherein the strength of the outer protector gradually increases a from an inside to an outside of the outer protector.

18. The protector of claim 16, wherein the outer protector includes a planar surface region defining a portion of the outer surface of the outer protector; and
wherein the planar surface region is inclined at a preset reference angle with respect to an axial direction of the pressure vessel.

19. The protector of claim 18, wherein the outer protector includes a stepped region provided at one end of the planar surface region, the stepped region configured to seat a binding band.

20. The protector of claim 19, wherein the outer protector includes:
a curved attachment region having a curvature corresponding to an outer surface of the dome part;
a rounded region formed between the stepped region and the planar surface region; and
a curved guide region provided at another end of the planar surface region and configured to guide the binding band.
